(19) United States
(12) Patent Application Publication
(10) Pub. No.: US 2009/0164266 A1
(43) Pub. Date: Jun. 25, 2009

(54) CATEGORY AGGREGATED OPINION DATA

(75) Inventors: SAMIR LAKHANI, SEATTLE, WA (US); LING BAO, SEATTLE, WA (US); MIRA LANE, SEATTLE, WA (US); EVAN MALAHY, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/962,236

(22) Filed: Dec. 21, 2007

(51) Int. Cl. G06F 17/00

(52) U.S. Cl. 705/7

(57) ABSTRACT

Embodiments of the present invention relate to aggregating opinion data and providing aggregated opinion data to a user. More specifically, opinion data may be aggregated by one or more categories, or by entity. Opinion data may be received from various sources and includes sentiment information (e.g., positive and negative comments) on a specific entity. The opinion data may be further aggregated by feature for each category.

### BACKGROUND

To assist a user in making a decision about purchasing a product or a service, many users consult opinions provided by other users or by editorial staffs. However, such opinions may be limited to a specific product or service or may only provide a limited opinion, and thus, the user may not be provided with adequate and/or accurate information to make informed decisions.

### SUMMARY

Embodiments of the present invention relate to aggregating opinion data by category. Such a method comprises, in part, receiving information, such as from a web page, that comprises opinion data, where the opinion data relates to one or more entities (e.g., products, services, people, brands, etc.). At least one category associated with the information is determined, and the information is aggregated by category to produce aggregated category opinion data, which then may be provided for presentation to the user. The opinion data may also be aggregated and provided by entity, and further by feature of the entity or category. Additionally, in some embodiments, the opinion data may be indexed, and may then be accessed when a search request is made by a user.

In another embodiment of the present invention, a method for displaying aggregated opinion data is provided that comprises, in part, displaying a first graphical user interface that presents aggregated opinion data by category, where the category includes one or more entities; determining whether the user requests an entity presented on the first graphical user interface; and, if so, displaying a second graphical user interface that presents opinion data related to the requested entity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of a computing system environment suitable for use in implementing the present invention;

FIG. 2 is a block diagram illustrating an exemplary system for aggregating opinion data, in accordance with an embodiment of the invention;

FIG. 3 is a block diagram illustrating a category aggregating component, in accordance with an embodiment of the present invention;

FIG. 4 is a flow diagram illustrating a method for aggregating opinion data, in accordance with an embodiment of the present invention;

FIG. 5 is an illustrative screen display, in accordance with an embodiment of the present invention, of an exemplary user interface showing aggregated opinion data by category;

FIG. 6 is an illustrative screen display, in accordance with an embodiment of the present invention, of an exemplary user interface showing aggregated opinion data by entity;

FIG. 7 is a flow diagram illustrating a method for displaying aggregated opinion data, in accordance with an embodiment of the present invention; and

FIG. 8 is a flow diagram illustrating a method for providing aggregated opinion data, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to aggregating opinion data and providing aggregated opinion data to a user. Aggregating opinion data, where the opinion data relates to one or more entities, provides the user with sentiment information and allows the user to view opinion data from various sources at a category level and/or an entity level. Within each level, the user may further view the opinion data by feature, so that, if a particular feature is of importance to the user, this may be displayed. In some embodiments, the aggregated opinion data is provided via a graphical user interface that displays the opinion data as aggregated by category. The user may then view a second graphical user interface displaying opinion data for a specific entity within the category.

In one embodiment of the invention, one or more computer storage media performing a method for aggregating opinion data is provided. The method comprises, in part, receiving information that comprises opinion data related to one or more entities; determining at least one category associated with the information; aggregating the information by category to produce aggregated category opinion data; and providing the aggregated category opinion data for presentation.

In another embodiment of the invention, a method for displaying aggregated opinion data is provided, comprising, in part, displaying a first graphical user interface presenting opinion data aggregated by category, where the category comprises one or more entities; determining whether a user requests opinion data associated with one of the entities; and if the user requests one of the entities, displaying a second graphical user interface presenting opinion data associated with the requested entity.

In yet another embodiment, one or more computer storage media performing a method for providing aggregated opinion data is provided. The method comprises, in part, receiving a search query associated with a category, where the category comprises one or more entities; extracting information that comprises opinion data related to the category, where the information is associated with at least one feature; aggregating the information to produce aggregated category opinion data; and providing the aggregated category opinion data by feature for presentation.

Having briefly described an overview of embodiments of the present invention, an exemplary operating environment suitable for use in implementing embodiments of the present invention is described below.

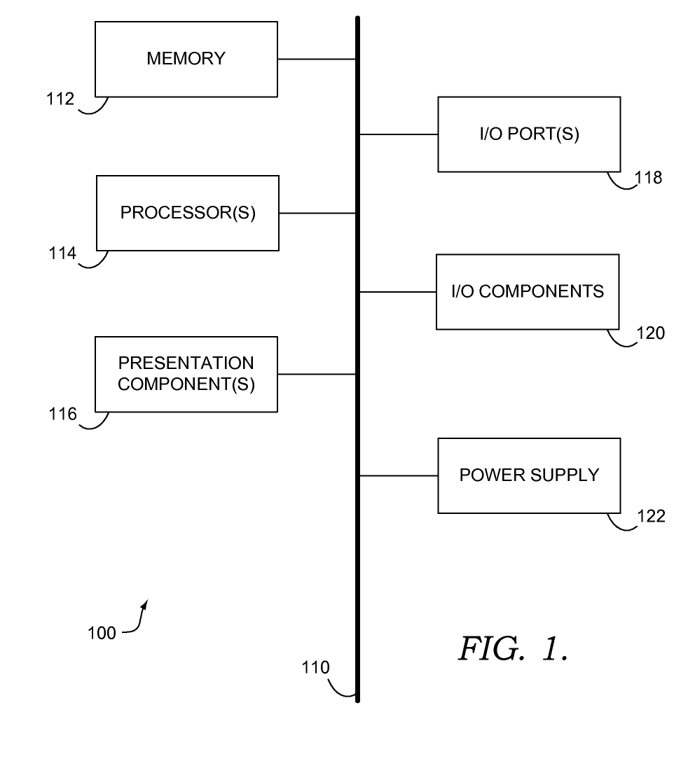

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, 1/0 components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CD-ROM, digital versatile discs (DVD) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

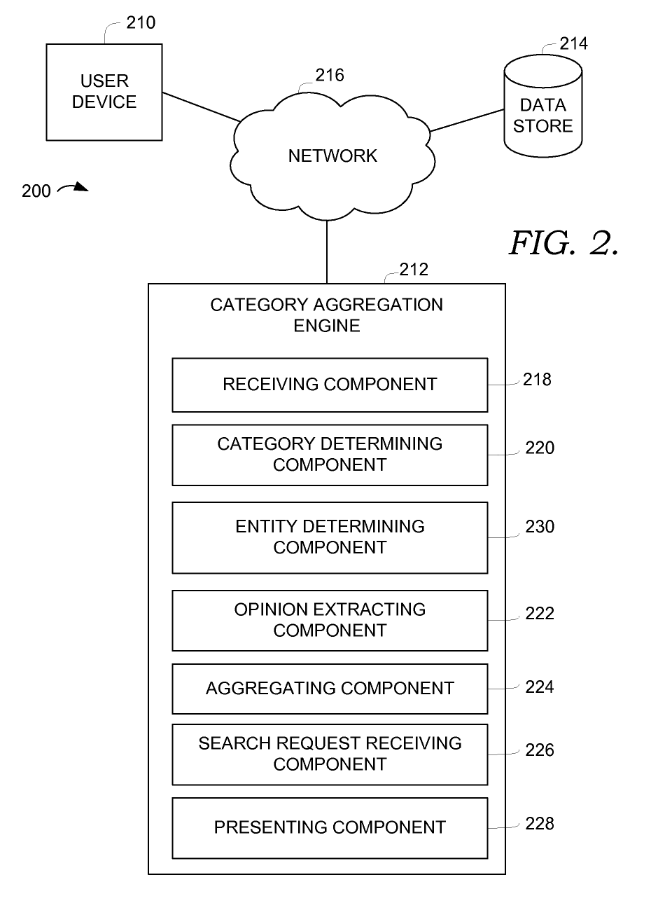

Turning now to FIG. 2, a block diagram is illustrated that shows an exemplary computing system 200 configured to aggregate opinion data, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated herein.

Computing system 200 includes a user device 210, a category aggregation engine 212, and a data store 214, in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 may be configured to store information associated with opinion data, as more fully described below. It will be understood and appreciated by those of ordinary skill in the art that the information stored in the data store 214 may be configurable and may include information relevant to opinion data that may be extracted for indexing. Further, though illustrated as a single, independent component, data store 214 may, in fact, be a plurality of data stores, for instance, a database cluster, portions of which may reside on a computing device associated with the category aggregation engine 212, the user device 210, another external computing device (not shown), and/or any combination thereof.

Each of the category aggregation engine 212 and the user device 210 shown in FIG. 2 may be any type of computing device, such as, for example, computing device 100 described above with reference to FIG. 1. By way of example only and not limitation, the category aggregation engine 212 and/or the user device 210 may be a personal computer, desktop computer, laptop computer, server computer, handheld device, mobile handset, consumer electronic device, and the like. It should be noted, however, that the present invention is not limited to implementation on such computing devices, but may be implemented on any of a variety of different types of computing devices within the scope of the embodiments hereof.

As shown in FIG. 2, the category aggregation engine 212 includes a receiving component 218, a category determining component 220, an entity determining component 230, an opinion extracting component 222, an aggregating component 224, a search request receiving component 226, and a presenting component 228. In some embodiments, one or more of the illustrated components 218, 220, 222, 224, 226, 228, and 230 may be integrated directly into the operating system of the category aggregation engine 212 or the user device 210. In the instance of multiple servers, embodiments of the present invention contemplate providing a load balancer to federate incoming queries to the servers. It will be understood by those of ordinary skill in the art that the components 218, 220, 222, 224, 226, 228, and 230 illustrated in FIG. 2 are exemplary in nature and in number and should not be construed as limiting. Any number of components may be employed to achieve the desired functionality within the scope of the embodiments of the present invention.

The receiving component 218 is configured for receiving opinion data from a variety of sources. Opinion data, as used herein, refers to data comprising sentiment information associated with one or more entities. An entity may be any specific subject for which opinion data may be received, such as specific products, services, people, brands, etc. Opinion data may represent opinions of third-party users (e.g., from user feedback), experts, and the like. Accordingly, the receiving component 218 is configured for receiving information from a variety of sources, such as a plurality of web pages, each source having opinion data associated therewith. Once received by the receiving component 218, the opinion data may be stored, for instance, in association with data store 214, and/or indexed as desired. Indexing is described more fully herein below. It will be appreciated that information may be received from various sources. In one embodiment, crawled documents or documents that are obtained by a web-crawler, are received. In another embodiment, feed documents, or documents of known relevance and format that are fed into the system, are received.

The category determining component 220 is configured for determining one or more categories associated with the opinion data received by receiving component 218. As used herein, a category refers to a term describing a group classifying the entity. For example, if the source provided opinion data for an entity, such as a Microsoft® Zune™, the category associated with this source of opinion data may be mp3 players. Accordingly, there could be multiple entities in each category. So, in this example, other mp3 players (e.g., an Apple® Ipod™) may be other entities associated with the mp3 player category.

It will be understood that an entity may be classified in more than one category, and further that the category may vary in its scope and may encompass another category. For example, “digital cameras” as a category may be more broadly classified as a “cameras” category, and “SLR digital cameras” could be another category with a more narrow scope. In an embodiment of the invention, the scope of each category is configurable, and may be adjusted for the user. For example, if the user was an experienced photographer, the user may desire opinion data on SLR digital cameras. The opinion data may then be aggregated at varying levels of category specificity to suit the needs of the user.

One skilled in the art will appreciate that a brand may also be a category. By way of example, without limitation, if the category was “Toyota,” entities could include the various models of cars sold by Toyota. Or, if the category was “Levi's,” entities could include different styles of jeans manufactured by Levi's.

The designation of the scope desired by the user may be determined in various ways. In one embodiment, the user may be asked, after requesting opinion data of a category, about their knowledge or skill level relevant to that category. In further embodiments, algorithms may be used to automatically determine such a designation. For example, the text entered by a user for a query may be analyzed and the relevant results may be used to determine the category. So, by way of example, without limitation, if a user searched for “330i,” relevant results produced might be for BMW coupes and sedans. From these results, it is determined that the user may want opinion data for categories, such as “luxury coupes” or “luxury sedans.”

The entity determining component 230 is configured for determining one or more entities associated with the opinion data received by receiving component 218. One or more entities are determined so that, in one embodiment, the opinion data may be aggregated by entity. Determination of one or more entities associated with the opinion data may also be used by the category determining component 220 to determine the one or more categories associated with the opinion data.

The opinion extracting component 222 is configured to extract features and sentiment information from the opinion data. One skilled in the art will appreciate that any suitable method may be used for extracting opinion data. Opinion data may include any sentiment information contained in a source, such as, for example, positive, negative, or neutral feedback. Alternatively, opinion data may be based on a scaled system (e.g., a ranking of one to five stars).

As discussed above, both crawled documents (e.g., documents that are obtained by a web-crawler) and feed documents (e.g., documents of known relevance and format that are fed into the system) may be accessed for opinion extraction. In one embodiment, the opinion extracting component 222 determines whether the crawled documents express opinions about the specific entity or entities for which aggregated opinion data is desired. Documents determined to be relevant, along with the feed documents of known relevance, are subjected to opinion extraction where components of an input document are identified (e.g., reviewer name, review body, review rating, etc.) that can aid in subsequent opinion identification.

Further, the sentiment information is associated with at least one feature. A feature, as used herein, refers to any aspect of an entity that may be described or for which an opinion may be rendered. For example, if the source information relates to an entity such as the Zune, various features associated with the source information could include sound quality, ease of use, battery life, appearance, etc. If, instead of a product, the category comprised entities related to a customer service (e.g., plumber), exemplary features associated with the opinion data may be reliability, customer service, and knowledge. If, for example, the given entity was a person, such as a president, a writer, an entertainer, etc., features associated with such an entity may include personal appearance, speaking ability, intelligence, and the like. It will be understood that a source may provide opinion data associated with only one feature or with more than one feature for a given entity. Thus, for example, a source may only include opinion data relating to a single feature, such as the sound quality of the Zune, or may include opinion data on several features, such as sound quality and battery life.

The search request receiving component 226 is configured for receiving a search request for which satisfying content is desired. By way of example, the search request may be received at a user interface as the result of user input. It will be understood and appreciated by those of ordinary skill in the art that multiple methods exist by which a user may input a search request. For instance, search requests may be input, by way of example only, utilizing a keyboard, joystick, trackball, touch-advertisement, or the like. Alternative user interfaces known in the software industry are contemplated by the invention. The search request is typically a user-initiated action or response that is received at a user interface, as discussed above. Examples of a request are a click, click-through, or selection by a user, e.g., human user or robotic user; however, it is understood and appreciated by one of ordinary skill in the art that a request may take any number of forms of indication at a web page. Further, it is contemplated by the present invention that a robotic user may be any non-human operator (i.e., an internet bot, web bot program, virus, robot, web crawler, web spidering program, or any software applications that run automated tasks over the Internet), which is an artificial agent that, by its actions, conveys a sense that it has intent or agency of its own. Even further, a human user is contemplated as being a human, but also, an entity (virtual or physical) acting under the present intent of a human operator. Upon receiving a search request, indexed, extracted opinion data may be queried to determine if satisfying data is present.

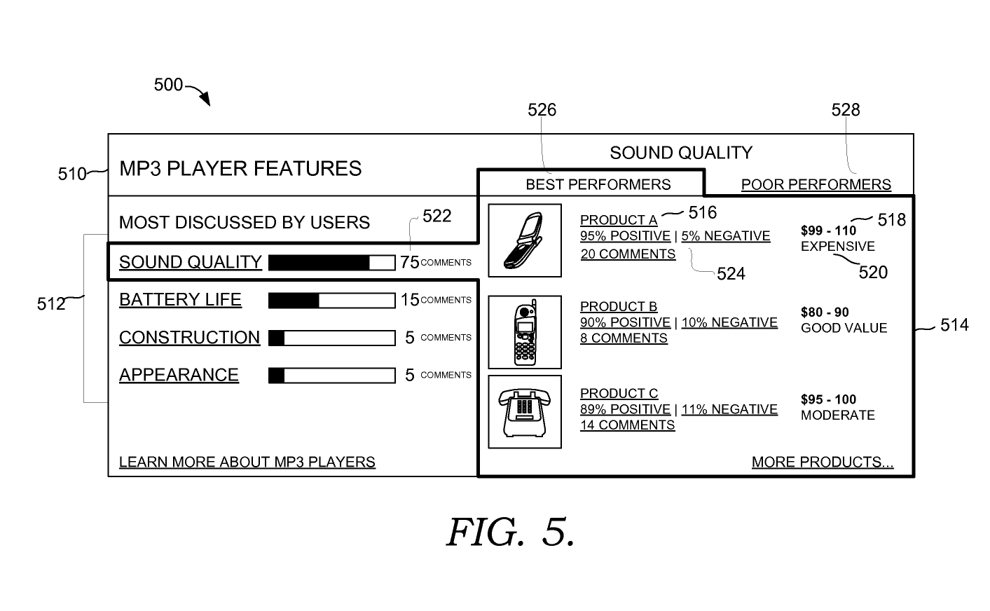

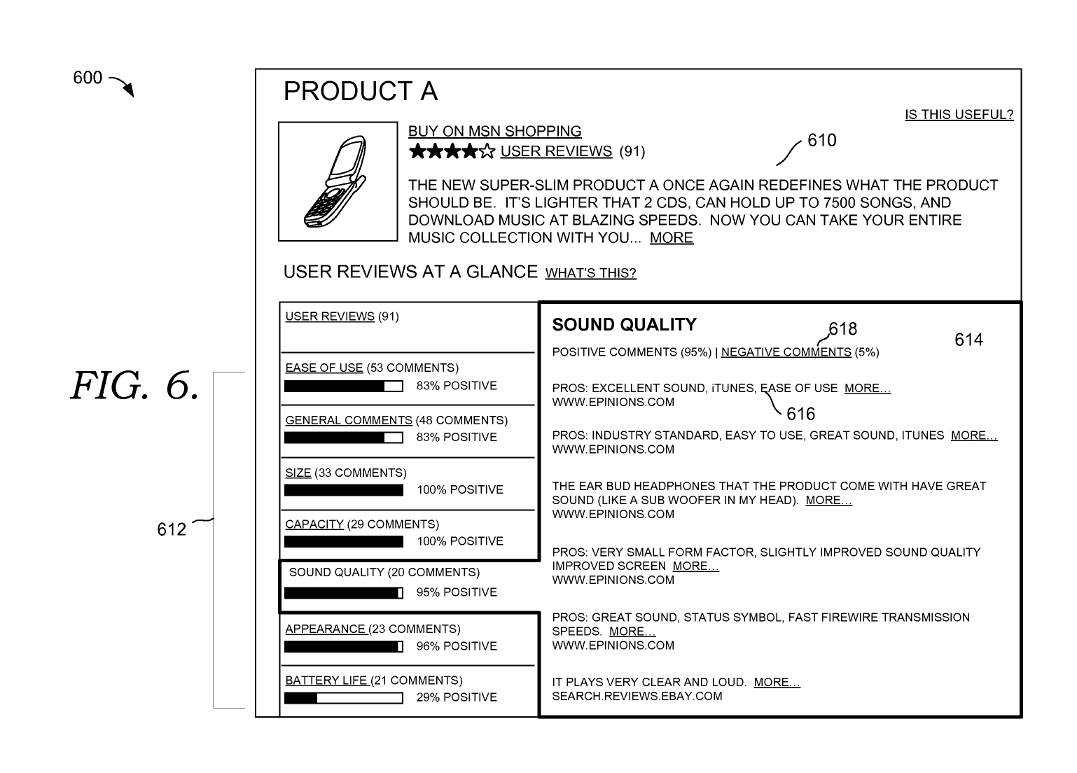

The presenting component 228 is configured for presenting aggregated opinion data related to at least one category to a user. Typically such presentation will be by way of display in association with a user interface. Exemplary user interfaces are discussed with respect to FIGS. 5 and 6, and will be discussed more fully below.

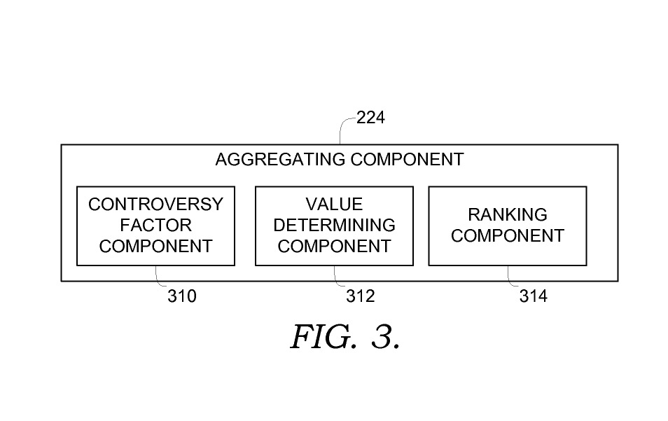

Referring now to FIG. 3, a further view of the aggregating component 224 is provided. Aggregation may occur at various levels, including at the category level or entity level. At the category level, all opinion data associated with an entity that relates to the given category is aggregated. In other embodiments, the opinion data may be aggregated at different category levels, as described above. In further embodiments, opinion data may be aggregated by entity. Thus, all opinion data associated with an entity is aggregated.

In embodiments of the invention, the aggregating component 224 may comprise a controversy factor component 310, a value determining component 312, and a ranking component 314. The controversy factor component 310 is configured to determine the controversy factor associated with opinion data received that relates to an entity. As used herein, a controversy factor refers to the most important feature for user when considering the opinion data on the entity. A controversy factor may be based on various factors and may be configured as necessary for the user. Exemplary methods include the feature or features most frequently discussed by multiple sources of opinion data (i.e., features that have received the most number of aggregated comments), or the feature or features that receive a varied of amount of positive and negative feedback. The controversy factor is used in the determination of what features to present to a user. That is, opinion data related to numerous features of an entity or category may be received. By determining the controversy factor, the features that are most important to the user can be determined, and thus aggregated and presented to the user.

In one embodiment, the value determining component 312 in FIG. 3 is configured to determine the entity or entities that provide the best value to the user. In making this determination, the value determining component 312 may use the average price or cost of each entity with the opinion data to compute the value of the entity, and may classify the value of an entity according to a predetermined standard. Opinion data is used to determine value along with the cost of the entity, so that, even though one entity might be more expensive, the value is high if the opinion data related to that feature is particularly high. For example, the entity with the best determined value may be classified as “the best value,” while other entities with lower determined values may be classified as “good value,” “moderate,” “expensive,” etc. Further, the value of each entity may be determined for each feature in the category of entities and/or may be determined overall giving consideration to all features associated with the category. The value determining component 312 may also determine the entities with the lowest value.

The ranking component 314 is configured to rank the entities in a category, based on the opinion data, in order to determine the entities that perform the best and worst in regards to a specific feature. For example, when the opinion data is aggregated by category and the user selects a feature associated with the category, those entities that have been ranked as top performers in that specific feature are presented. The poor performers that are ranked lowest for the entities may also be presented to the user. In another embodiment, the ranking component 314 ranks brands based on the aggregated opinion data. So, by way of example, without limitation, the top brands may be presented to the user.

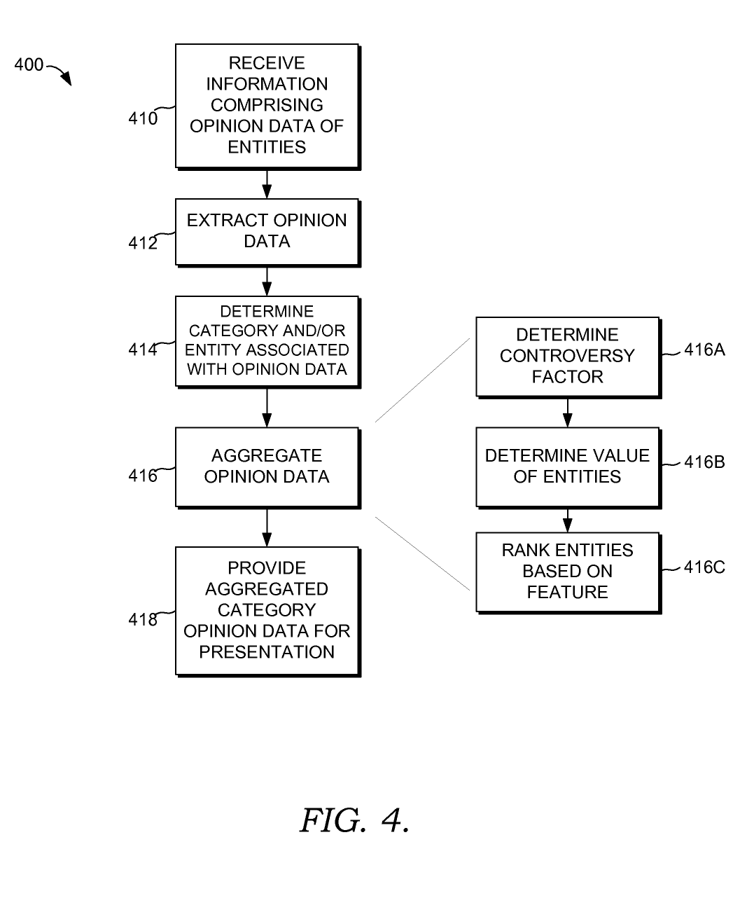

Turning now to FIG. 4, an exemplary method for aggregating opinion data is illustrated and labeled generally as reference numeral 400. Initially, as indicated in block 410, information is received, where the information is associated with opinion data of one or more entities (e.g., by utilizing receiving component 218 in FIG. 2). In block 412, opinion data from the sources of information is extracted (e.g., by utilizing extracting component 222 in FIG. 2). From the extracted opinion data, the entity or entities associated with the opinion data may be determined, as well as the features related thereto. Further, within the opinion data, the sentiment information is determined and summarized. The sentiment information may be manually determined or may be determined algorithmically and can be summarized in various ways. For example, sentiment information may be identified as a positive or negative comment, and the number of positive and negative comments can be tracked.

Subsequently, in block 414, the category and/or entity associated with the opinion data is determined, for instance, by category determining component 220 or entity determining component 230 in FIG. 2. As discussed above, the opinion data of the entity may be associated with more than one category. The opinion data is then aggregated, as is shown at block 416, by either category or entity. In one embodiment, the aggregated opinion data is analyzed to determine a controversy factor (e.g., by utilizing controversy factor component 310 in FIG. 3), where the controversy factor comprises a feature associated with the opinion data of the entity. This is shown at block 416A. In another embodiment, the aggregated opinion data is analyzed and the value of each of the one or more entities is determined (e.g., by utilizing value determining component 312 in FIG. 3). As discussed above, the entities may be given a value based on each feature and/or may be given a value within the determined category based on all features associated with the category. This is shown at block 416B. In yet another embodiment, the one or more entities in a determined category are ranked, for instance, by utilizing ranking component 314 in FIG. 3. One skilled in the art will appreciate that ranking the entities will vary depending on the category and features associated therewith. An entity may be ranked for each feature, and for example, the best entities may be classified by a ranking (such as “top performers”), and the worst entities for a given feature may be classified by another ranking (such as “poor performers”). This is shown at block 416C. At block 418, the aggregated opinion data is provided for presentation, for instance, by utilizing the presenting component 228 in FIG. 2.

It will be understood by those of ordinary skill in the art that the order of steps shown in the method 400 of FIG. 4 are not meant to limit the scope of the present invention in any way and, in fact, the steps may occur in a variety of different sequences within embodiments hereof. Any and all such variations, and any combinations thereof, are contemplated to be within the scope of embodiments of the present invention.

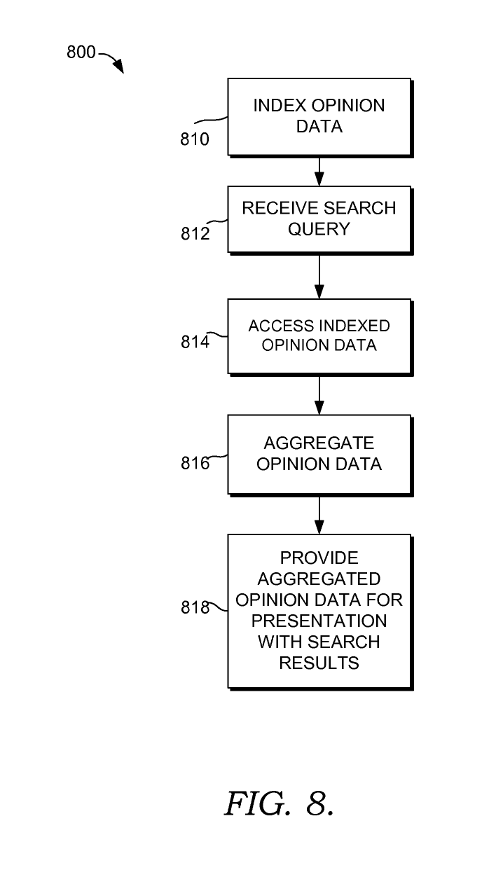

In FIG. 8, a method for providing aggregated opinion data, in accordance with an embodiment of the invention, is provided. At block 810, the opinion data is indexed, as discussed above with respect to receiving component 218 in FIG. 2. Subsequently, at block 812, a user may input a search request (e.g., utilizing search request receiving component 226) and indexed, extracted opinion data may be queried to determine if satisfying content is present. At block 814, such opinion data may be accessed from the indexed opinion data. If, for example, the indexed opinion data is stored (e.g., in association with data store 214 in FIG. 2), the opinion data may be accessed from this location. At block 816, the accessed opinion data is aggregated. The opinion data, as previously discussed, may be aggregated by category or categories, and/or by entity. Then, at block 818, the aggregated opinion data is provided for presentation within search results.

As previously mentioned, aggregated opinion data may be presented utilizing a variety of user interface features. Such features may include, by way of example only, novel user interface elements presented with respect to a web (or other source) page. Without limitation, a number of user interface features are described herein below with reference to FIGS. 5 and 6. It will be understood by those of ordinary skill in the art that a number of other user interface features may be utilized to present aggregated opinion data in accordance with embodiments hereof and that the user interface features shown in FIGS. 5 and 6 are meant to be illustrative of some such features.

Referring now to FIG. 5, an illustrative screen display is shown, in accordance with an embodiment of the present invention, of an exemplary user interface 500 showing aggregated opinion data. In the illustrated user interface 500, the opinion data is associated with the category of mp3 players 510. Examples of features associated with the opinion data related to the category of mp3 players are shown at 512, and include sound quality, battery life, construction, and appearance. Additionally, a summary of the sentiment information for each feature within the category is shown at 522. In this embodiment, such a summary is illustrated by displaying the number of comments on that specific feature and a scale showing how positive or negative the comments are.

In the embodiment of the user interface shown in FIG. 5, the feature “sound quality” has been selected. As a result of this selection, entities, such as Products A, B, and C, are listed in the display area 514. Product A is shown as 516 in FIG. 5. At 524, the summary of sentiment information at the entity level is shown for the specific feature selected. Thus, in this embodiment, the twenty comments about Product A are all related to its sound quality, and 95% of those comments have been positive with 5% being negative. The prices of the entities, such as the price of Product A shown as 518, may also be displayed in embodiments of the user interface. As discussed above, the prices of the entities may be used to determine a value of each entity. Here, Product A has been given a value for the selected feature of sound quality of “Expensive” as is shown at 520. If another feature (e.g., battery life) was selected, the value of Product A may be different.

Furthermore, the entities are ranked based on predetermined standards, as discussed above. Note that display area 514 displays the best performers 526 for the sound quality feature. If poor performers 528 were selected, the worst performers for that feature would be presented. In another embodiment, where the entity was a brand, the top brands may be presented, as well as the poor brands.

Referring now to FIG. 6, an illustrative screen display is shown, in accordance with an embodiment of the present invention, of an exemplary user interface 600 showing opinion data at an entity level. More specifically, opinion data has been requested for Product A (shown as 516 in FIG. 5) by the user, and consequently, the user interface 600 displays the requested opinion data 610 of Product A. The features associated with opinion data related to this entity are shown at 612. Next to each feature, the summarized sentiment information is shown for each feature (e.g., 95% positive for sound quality). The feature, “Sound Quality,” is selected in FIG. 6, and thus display area 614 shows the opinion data associated with Product A that relates to its sound quality. At 618, the summarized sentiment information is shown for that feature. The opinion data displayed herein may include the source of the information associated with the opinion data, such as the web page shown at 616. Additionally, the price of the entity may be displayed and a value determination made based on this price. For example, if a price was included in the source of information with the opinion data, this information may be extracted and presented to the user.

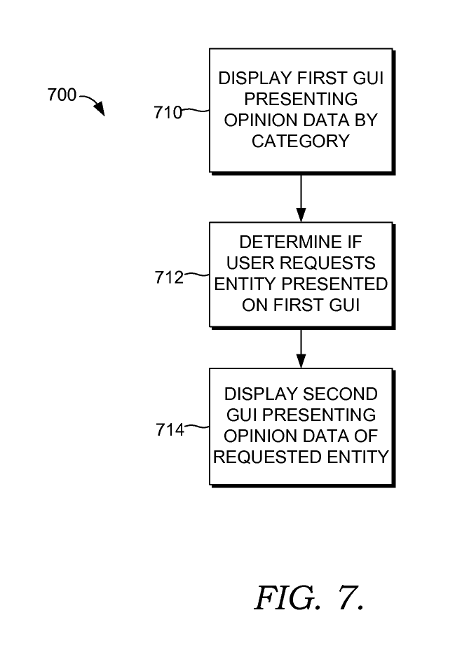

Referring now to FIG. 7, an exemplary method for displaying aggregated opinion data is illustrated and labeled generally as reference numeral 700. Initially, as indicated at block 710, a first graphical user interface is displayed, which presents aggregated opinion data by category. An example of such a graphical user interface is shown in FIG. 5, discussed above. The first graphical user interface presents summarized category opinion data by feature and presents the number of entities within the category for a selected feature. Next, at block 712, it is determined whether the user requests opinion data associated with an entity presented on the first graphical user interface, for instance, Product A in FIG. 5. If it is determined that the user has requested an entity presented on the first graphical user interface, as indicated at block 714, a second graphical user interface may be displayed presenting the opinion data of the requested entity. An example of such a graphical user interface is shown in FIG. 6. The second graphical user interface presents summarized opinion data for each entity and presents actual comments and opinion data for the selected feature.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all of the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer storage media having computer-executable instructions embodied thereon for performing a method (400) for aggregating opinion data, the method comprising:
receiving (410) information that comprises opinion data related to one or more entities;
determining (414) at least one category associated with the information;
aggregating (416) the information by the at least one category to produce aggregated category opinion data; and
providing (418) the aggregated category opinion data for presentation.

2. The computer storage media of claim 1, further comprising extracting (412) the opinion data from the information.

3. The computer storage media of claim 1, further comprising determining (416B) a value for each of the one or more entities, wherein the value is based on a price of the entity and the opinion data associated with the entity.

4. The computer storage media of claim 3, wherein the one or more entities are ranked based on their determined value.

5. The computer storage media of claim 4, wherein the one or more entities are ranked within the at least one category.

6. The computer storage media of claim 4, wherein the one or more entities are ranked for a selected feature within the at least one category.

7. The computer storage media of claim 1, further comprising determining (416A) a controversy factor.

8. The computer storage media of claim 1, further comprising ranking the one or more entities within a selected feature based on the opinion data associated with the feature.

9. A method (700) for displaying aggregated opinion data, comprising:
displaying (710) a first graphical user interface presenting opinion data aggregated by category, wherein the category comprises one or more entities;
determining (712) whether a user requests opinion data associated with one of the one or more entities; and
if the user requests one of the one or more entities, displaying (714) a second graphical user interface presenting opinion data associated with the requested entity.

10. The method of claim 9, wherein the opinion data is associated with one or more features.

11. The method of claim 10, wherein the first graphical user interface presents the opinion data by the one or more features.

12. The method of claim 9, further comprising determining a value for each of the one or more entities, wherein the value is based on a price of the entity and the opinion data associated with the entity.

13. The method of claim 12, wherein the first graphical user interface presents the value of each of the one or more entities.

14. The method of claim 12, further comprising ranking the one or more entities based on the determined value of each of the one or more entities.

15. The method of claim 14, wherein the first graphical user interface presents the ranking of the one or more entities.

16. The method of claim 10, further comprising determining a controversy factor.

17. The method of claim 10, wherein the second graphical user interface presents the opinion data associated with the requested entity by one or more features.

18. One or more computer storage media having computer-executable instructions embodied thereon for performing a method (800) for providing aggregated opinion data, the method comprising:
receiving (812) a search query associated with at least one category, wherein the at least one category comprises one or more entities;
extracting (814) information that comprises opinion data related to the at least one category, wherein the information is associated with at least one feature;
aggregating (816) the information to produce aggregated category opinion data; and
providing (818) the aggregated category opinion data by feature for presentation.

19. The computer storage media of claim 18, further comprising indexing (810) the information that comprises opinion data related to the at least one category to a data store.

20. The computer storage media of claim 19, wherein the information is accessed from the indexed data store.
